(19) United States
(12) Patent Application Publication
(10) Pub. No.: US 2016/0018284 A1
(43) Pub. Date: Jan. 21, 2016

(54) RESONANCE GENERATING DEVICE FOR TESTING FATIGUE OF BLADE THAT MAXIMIZES MOVING MASS RATIO AND FATIGUE TESTING METHOD USING SAME

(71) Applicant: KOREA INSTITUTE OF MACHINERY AND MATERIALS, Daejeon (KR)

(72) Inventors: HAK GU LEE, Changwon-si (KR); JI SANG PARK, Changwon-si (KR); DO YOUNG KIM, Buan-gun (KR); SOON HO YOON, Incheon (KR)

(73) Assignee: KOREA INSTITUTE OF MACHINERY AND MATERIALS, Daejeon (KR)

(21) Appl. No.: 14/870,299

(22) Filed: Sep. 30, 2015

Related U.S. Application Data
(63) Continuation of application No. PCT/KR2014/004535, filed on May 21, 2014.

(51) Int. Cl. G01M 7/02

(52) U.S. Cl. CPC G01M 7/022

(57) ABSTRACT

The present invention relates to a resonance generating apparatus with maximized moving mass ratio for a blade's fatigue testing, which includes a light-weighted mounting portion provided in contact with an external surface of the blade, a plurality of actuators provided on an external side of the mounting portion, and a resonance generator configured to generate bending loads in association with displacement of rods of the actuators, and to reciprocate in parallel relationship with a moving direction of the actuator rod and simultaneously to prevent the resonance generator's motions in all directions except for a direction of testing, and a fatigue testing method using the same.

### TECHNICAL FIELD

The present invention relates to a resonance generating apparatus with maximized moving mass ratio for a blade's fatigue testing, and more particularly, to a resonance generating apparatus with maximized moving mass ratio for a blade's fatigue testing, which includes a light-weighted mounting portion provided in contact with an external surface of the blade, a plurality of actuators provided on an external side of the mounting portion, and a resonance generator configured to generate bending loads in association with displacement of the actuator rods, and to reciprocate in parallel relationship with a moving direction of the actuator and simultaneously to prevent the resonance generator's motions in all directions except for a direction of testing, and a fatigue testing method using the same.

The present invention relates to a resonance generating apparatus with maximized moving mass ratio and improved rigidity for a blade's fatigue testing, in which a weight frame, housing actuator therein for moving in association with the actuator, is formed in a close-loop form, and a fatigue testing method using the same.

The present invention relates to a resonance generating apparatus with maximized moving mass ratio for a blade's fatigue testing, which is light-weighted because a resonance generator takes up most weight of the resonance generating apparatus, and which provides increased user convenience because additional weights are attachable to or detachable from the resonance generator, and a fatigue testing method using the same.

### BACKGROUND ART

Wind turbine blades for the purpose of wind power generation are somewhat distinguished from blades for aviation which are configured to generate lift, thrust and control forces, as the blades for wind power generation are configured to obtain rotary forces necessary to rotate an electric generator to thus produce electric power. The rotation of the blades causes aerodynamic force distribution around the blades, and this phenomenon acts as bending loads and torsional loads on the blades. Accordingly, an apparatus is necessary, which can monitor aerodynamic loads for safe operation of the blades, and also measure aerodynamic force distribution in spanwise direction of the blades. Accordingly, the resonance generating apparatus for simulating aerodynamic force distribution has been developed in a variety of forms.

For example, Korean Patent Publication No. 10-2011-0078999 discloses an apparatus for measuring aerodynamic load (see FIG. 1), which includes a calibration device 40 as one of the components thereof. The calibration device 40 includes a plurality of rings 41, 42, 43, 44 to receive weights thereon, and spaces 45 to receive blades therein. However, since the calibration device 40 measures the aerodynamic loads in a manner in which end of wire is connected to the rings 41, 42, 43, 44 and torsion is repeatedly exerted, such way of measuring has limited accuracy of fatigue measurement.

For another example, WO2009/135136 discloses a system 1 for resonant testing on blade 2 using linearly-reciprocating actuators 10, 20, 30 (see FIG. 2).

However, the conventional technologies including the above examples has a shortcoming that the system 1 to perform resonance test of the blade 2 takes high amount of cost, and that resonance frequency decreases because the system's boundary condition is far from the clamped condition of the cantilever beam.

FIG. 3 is a schematic view of fatigue testing equipment developed by the National Renewable Energy Laboratory (USA). The fatigue testing equipment includes a frame 7 formed on an upper surface of the blade, and an actuator 5 formed in the frame 7 for linear reciprocation in a perpendicular direction. Weights 6 can be hung at a lower end of the actuator 5 to oscillate the blade in perpendicular direction.

However, the conventional constitution like the one explained above has a shortcoming of deteriorating durability of the hydraulic actuator, because loads in a blade's spanwise direction and chordwise direction on the weights 6 at the lower end of the actuator 5 can make the actuator's sealing parts worn out during oscillation of the blade.

FIG. 4 is a schematic view of another fatigue testing equipment developed by NREL, USA. The fatigue testing equipment includes actuators 8 on left and right sides, respectively, and an actuator 8 configured to linearly reciprocate weight 9 in perpendicular direction to thus generate a blade's vibration amplitude.

However, the above construction has a shortcoming of oil leakage, because side loads are generated on the actuators 8 due to misalignment between operating line of the actuators 8 and the center of gravity of the weight 9, which inevitably causes wear of the seal on the actuators 8 and leakage of oil.

FIG. 5 is a schematic view of UREX system developed by MTS. The UREX system includes actuators A mounted on both sides of a blade saddle P, with additional weight (W) mounted on the actuators A in the chord direction (i.e., widthwise direction) of the blade B.

To place the actuators A in the chordwise direction of the blade B, it is necessary to align the center of gravity of an excitation apparatus in thickness direction (i.e., in perpendicular direction) of the blade to the pitch axis. By doing so, the side loads generated by the motion of the blade during resonance testing can be reduced.

However, notwithstanding the advantages mentioned above, the UREX system is in such a construction that is not suitable for the purpose of exciting large-scale blade. That is, because additional weight (W) is mounted in only one direction of the actuators A, when the additional weight increases, the center of gravity of mass of moving object is distanced away from the axis of the actuator rod, thus causing side loads to be generated on the actuators A. As a result, its durability decreases, since wear of the actuator seal is accelerated.

### DISCLOSURE

### Technical Problem

The present invention has been made to solve the problems occurring in the prior art explained above, and accordingly, it is an object of the present invention to provide a resonance generating apparatus with maximized moving mass ratio for a blade's fatigue testing, and more particularly, to a resonance generating apparatus for a blade's fatigue testing with maximized moving mass ratio, which includes a light-weighted mounting portion provided in contact with an external surface of the blade, a plurality of actuators provided on an external side of the mounting portion, and a resonance generator configured to generate bending loads in association with displacement of rods of the actuators, and to reciprocate in parallel relationship with a moving direction of the actuator and simultaneously to prevent the resonance generator's motions in all directions except for a direction of testing, and a fatigue testing method using the same.

It is another object of the present invention to provide a resonance generating apparatus for a blade's fatigue testing with maximized moving mass ratio, which has improved rigidity because a weight frame, housing actuator therein for moving in association with the actuator body, is formed in a close-loop shape, and a fatigue testing method using the same.

It is yet another object of the present invention to provide a resonance generating apparatus with maximized moving mass ratio for a blade's fatigue testing, which is light-weighted because a resonance generator takes up most weight of the resonance generating apparatus, and which provides improved user convenience because weights are attachable to or detachable from the resonance generator, and a fatigue testing method using the same.

### Technical Solution

To achieve the above objects, the present invention provides a resonance generating apparatus for a blade's fatigue testing with maximized moving mass ratio, which may comprise a mounting portion comprising a saddle comprising a groove corresponding in form to an external surface of the blade, and an assembling portion provided outside the saddle to be tightened with a tightening member so that the saddle exerts a pressure on the blade; a resonance generator comprising an actuator to generate linear movement, a weight frame which houses an actuator or actuators therein, has a closed-loop configuration to improve structural rigidity, and which linearly reciprocates in association with a displacement of the actuator rod, and a linear guide configured to guide the linear reciprocation of the weight frame when the actuator rod displaces; and additional weights mounted on opposed surfaces of the weight frame to be moved in association with the weight frame, and added or reduced in number in a lengthwise direction of the blade to position the center of gravity of moving masses to the rod during linear reciprocation of the weight frame.

In another embodiment, a fatigue testing method using a resonance generating apparatus for a blade's fatigue testing is provided, which may comprise: installing a mounting portion on the blade, the mounting portion comprising a saddle including a groove corresponding in form to an external surface of the blade, and an assembling portion provided outside the saddle to be tightened with a tightening member so that the saddle exerts a pressure on the blade; installing a resonance generator on one side of the mounting portion, the resonance generator comprising an actuator to generate linear movement, a weight frame which houses an actuator or actuators therein, has a closed-loop configuration to improve structural rigidity, and which linearly reciprocates in association with a displacement of the actuator rod, and a linear guide configured to guide the linear reciprocation of the weight frame when the actuator rod displaces; installing additional weights on one side of the resonance generator, the weights being mounted on opposed surfaces of the weight frame to be moved in association with the weight frame, and added or reduced in number in a lengthwise direction of the blade to position the center of gravity of moving masses to the rod during linear reciprocation of the weight frame; and generating resonance on the blade by linearly reciprocating the actuator rod and accordingly moving the weight frame and the additional weights.

### Advantageous Effects

According to the present invention, a light-weighted mounting portion is provided in contact with an external surface of the blade, a plurality of actuators are provided on an external side of the mounting portion, and a resonance generator, which is configured to generate bending loads in association with displacement of actuator rods, reciprocates in parallel relationship with a moving direction of the actuator, while being restrained from moving in all directions except for a direction where the resonance is generated.

According to the present invention, moving masses of the moving resonance generator take up most weight of the resonance generating apparatus, and the weight frame, which is a main component of the resonance generator, is formed into a closed loop configuration. Accordingly, the resonance generating apparatus can be light-weighted, and have improved strength and durability.

Further, since weights are attachable to and detachable from one side of the resonance generator, user convenience increases.

### BRIEF DESCRIPTION OF THE DRAWINGS

FIG. 1 is a perspective view of a calibrating device as disclosed in KR Patent Publication No. 10-2011-0078999;

FIG. 2 is a schematic view of a resonance test system as disclosed in WO2009/135136;

FIG. 3 is a schematic view of fatigue testing equipment developed by the National Renewable Energy Laboratory (USA);

FIG. 4 is a schematic view of another fatigue testing equipment developed by NREL (USA);

FIG. 5 is a schematic view of the UREX system developed by MTS;

FIG. 6 is a perspective view of a resonance generating apparatus for blade fatigue testing purpose in installed state, according to the present invention;

FIG. 7 is a perspective view of an outer constitution of a resonance generating apparatus for blade fatigue testing, according to the present invention;

FIG. 8 is a perspective view illustrating a weight frame as one of the components of a resonance generating apparatus for blade fatigue testing being moved upward, according to the present invention;

FIG. 9 is a perspective view of a mounting portion as one of the components of the resonance generating apparatus for blade fatigue testing, according to the present invention;

FIG. 10 is an exploded perspective view of a resonance generator as a main constitution of a resonance generating apparatus for a blade's fatigue testing, according to an embodiment of the present invention;

FIG. 11 is an exploded perspective view of a constitution of a resonance generating apparatus for a blade's fatigue testing, according to another embodiment of the present invention;

FIG. 12 is a cross section view of a constitution of a linear guide of a resonance generating apparatus for a blade's fatigue testing, according to an embodiment of the present invention;

FIG. 13 is a cross section view of a constitution of a linear guide of a resonance generating apparatus for a blade's fatigue testing, according to another embodiment of the present invention;

FIG. 14 is a perspective view of another constitution of a mounting portion as one of components of a resonance generating apparatus for a blade's fatigue testing, according to an embodiment of the present invention;

FIG. 15 is a perspective view of a resonance generating apparatus for a blade's fatigue testing in installed state, according to another embodiment of the present invention;

FIG. 16 is a front view of a resonance generating apparatus for a blade's fatigue testing in installed state, according to another embodiment of the present invention;

FIG. 17 is a cross-section view of a linear guide of a resonance generating apparatus for a blade's fatigue testing, according to another embodiment of the present invention; and

FIG. 18 is a flowchart provided to explain a method for testing fatigue using a resonance generating apparatus for a blade's fatigue testing, according to an embodiment of the present invention.

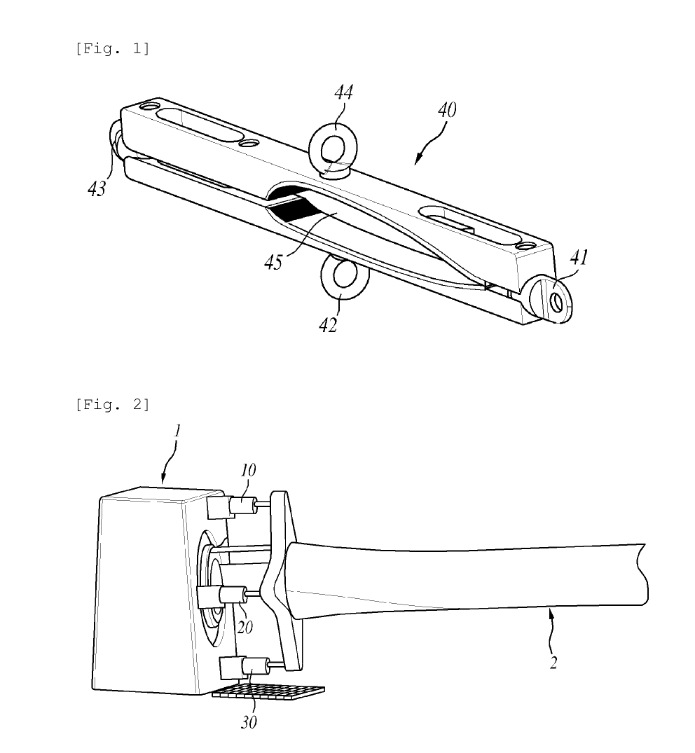

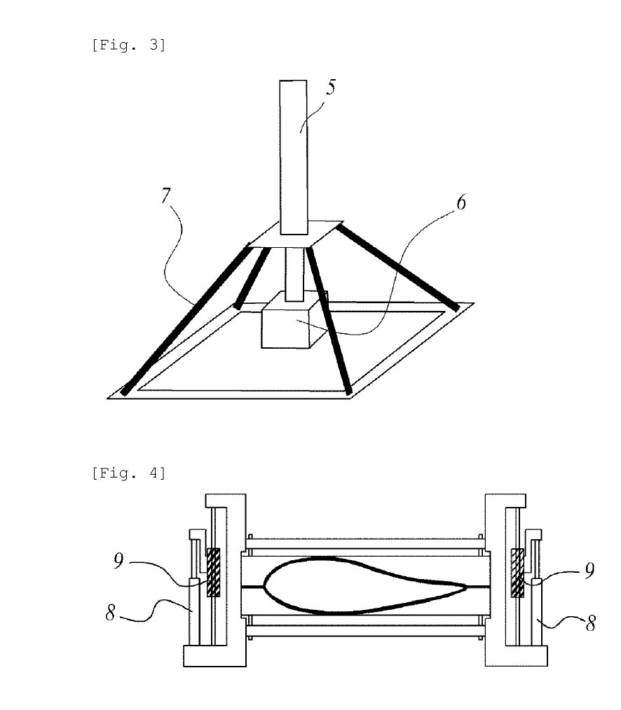

### DESCRIPTION OF REFERENCE NUMERALS

100: mounting portion
110: saddle
112: groove
116: leftward and rightward restraint
117: forward and backward restraint
118: tightening member
119: blocker
120: assembling portion
200: resonance generator
220: weight frame
240: actuator
242: actuator rod
244: actuator body
246: flowrate regulator
280: linear guide
282: coupler
284: moving portion
285: flange
286: fixing portion
287: hole
300: connector
B: blade
E: resonance generating apparatus
W: additional weight

### BEST MODE

In one embodiment, a resonance generating apparatus for a blade's fatigue testing with maximized moving mass ratio is provided, which may comprise a mounting portion comprising a saddle comprising a groove corresponding in form to an external surface of the blade, and an assembling portion provided outside the saddle to be tightened with a tightening member so that the saddle exerts a pressure on the blade, a resonance generator comprising an actuator to generate linear movement, a weight frame which houses an actuator body and an actuator rod therein, has a closed-loop configuration to improve structural rigidity, and which linearly reciprocates in association with a displacement of the actuator rod, and a linear guide configured to guide the linear reciprocation of the weight frame when the actuator rod displaces, and additional weights mounted on opposed surfaces of the weight frame to be moved in association with the weight frame, and added or reduced in number in a lengthwise direction of the blade to position the center of gravity of moving masses to the rod during linear reciprocation of the weight frame.

The linear guide may include a moving portion configured to move linearly in association with the actuator, and a fixing portion configured to guide a direction of movement of the moving portion.

A center of gravity of the resonance generator may preferably be positioned at a pitch axis, when displacement of the actuator is “0”.

A center of gravity of the mounting portion may preferably be on a pitch axis.

The linear guide may guide the movement of the weight frame to a direction parallel to a direction in which the actuator is extended or contracted. On the contrary, the linear guide may restrain the movement of the weight frame to a direction across a direction in which the actuator is extended or contracted.

The weight frame may be open in a widthwise direction of the blade.

The resonance generating apparatus may include a blocker provided between the mounting portion and the resonance generator to limit movement of the mounting portion with respect to the resonance generator when the resonance generator generates resonance.

The connector may preferably be formed from composite materials.

The saddle may be changed to another position and fixed therein in a lengthwise direction of the connector.

The resonance generator may additionally include a coupler to engage the actuator body to the assembling portion.

The linear guide may preferably be positioned on a straight line which is extended through centers of gravity of the weights mounted on the facing surfaces of the weight frame. In one embodiment, a fatigue testing method using a resonance generating apparatus with a maximized moving mass ratio for a blade's fatigue testing is provided, which may comprise installing a mounting portion on the blade, the mounting portion comprising a saddle comprising a groove corresponding in form to an external surface of the blade, and an assembling portion provided outside the saddle to be tightened with a tightening member so that the saddle exerts a pressure on the blade, installing a resonance generator on one side of the mounting portion, the resonance generator comprising an actuator to generate linear movement, a weight frame which houses an actuator or actuators therein, has a closed-loop configuration to improve structural rigidity, and which linearly reciprocates in association with a displacement of the actuator rod, and a linear guide configured to guide the linear reciprocation of the weight frame when the actuator rod displaces, installing additional weights on one side of the resonance generator, the weights being mounted on opposed surfaces of the weight frame to be moved in association with the weight frame, and added or reduced in number in a lengthwise direction of the blade to position the center of gravity of moving masses to the rod during linear reciprocation of the weight frame, and generating resonance on the blade by linearly reciprocating the actuator rod and accordingly moving the weight frame and the additional weights.

The installing the mounting portion may include installing the mounting portion so that a center of gravity thereof is positioned on a pitch axis.

The installing the additional weights may include positioning the linear guide on a straight line which is extended through respective centers of gravity of the weights mounted on the opposed surfaces of the weight frame.

In the generating of the resonance, the generated resonance may have one direction between a flap direction and an edge direction for a direction for a blade's fatigue testing, depending on a position at which the resonance generator is installed.

The generating the resonance may include generating bending or torsion in directions of the resonance generated at the blade, according to directions in which the actuator rods are moved.

### MODE FOR INVENTION

Hereinafter, the present invention will be explained in more detail with reference to the following Examples. However, the following Examples are only provided only for illustrative purpose, and therefore, do not limit the scope of the present invention.

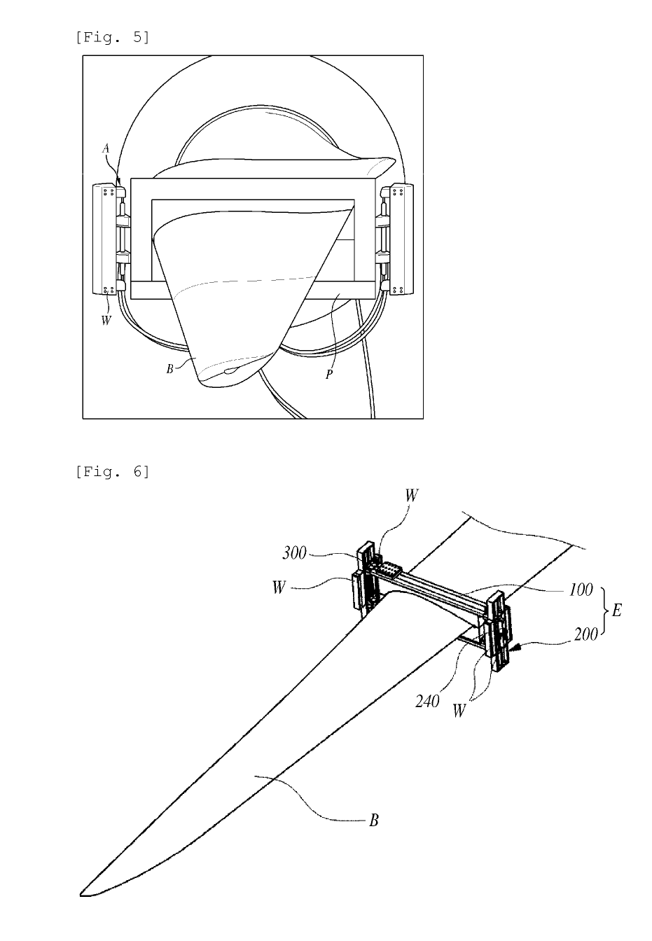

The resonance generating apparatus for a blade's fatigue testing (hereinbelow, ‘resonance generating apparatus’ E) according to an embodiment of the present invention in use will be explained below, with reference to FIG. 6.

FIG. 6 is a perspective view of the resonance generating apparatus E for a blade's fatigue testing in installed state, according to the present invention. As illustrated in FIG. 6, the resonance generating apparatus E is connected to an external surface of the subject of fatigue testing (i.e., a blade B) to generate resonance, in which the blade B is tightened to a fixed state while being passed through interior of the resonance generating apparatus E.

That is, the resonance generating apparatus E includes a mounting portion 100 integrally connected in contact with the external surface of the blade B, and a plurality of resonance generators 200 connected to an external side of the mounting portion 100 to generate resonance on the blade B by linearly reciprocating with respect to the mounting portion 100 in association with lengthwise extension and contraction of the actuator 240.

The resonance generating apparatus E includes additional weights W on left and right sides, and the additional weights W are addable or reducible in number depending on the size, shape and center of gravity of the blade B.

To be more specific, the additional weights W are provided on the respective resonance generators 200. The additional weights W are positioned on an external side on a widthwise direction of the blade B, and fixed in position to face each other in the widthwise direction of the resonance generating apparatus E (i.e., lengthwise direction of the blade B).

The resonance generators 200 of the resonance generating apparatus E, which are configured to generate resonance by moving upward and downward with respect to the blade B, are positioned on the external side, and take up most weight of the total weight of the resonance generating apparatus E. That is, the resonance generators 200 are positioned on the external side of the mounting portion 100, and linearly reciprocate in upward and downward directions with the additional weights W hung thereon.

Accordingly, among a plurality of constituent components of the resonance generating apparatus E, the resonance generators 200 are the main constituent components, which take up most weight of the resonance generating apparatus E. Accordingly, the total weight of the resonance generating apparatus E is reduced.

A connector 300 is formed between each resonance generator 200 and the mounting portion 100. The connector 300 is connected to upper and lower ends of the mounting portion 100, and connected at external side thereof to each resonance generator 200, thus connecting each resonance generator 200 and the mounting portion 100.

As explained above, the connector 300 may be employed to connect the resonance generators 200 and the mounting portion 100, but not limited thereto. For example, the resonance generators 200 may be directly connected with the mounting portion 100, in which case the connector 300 may be omitted.

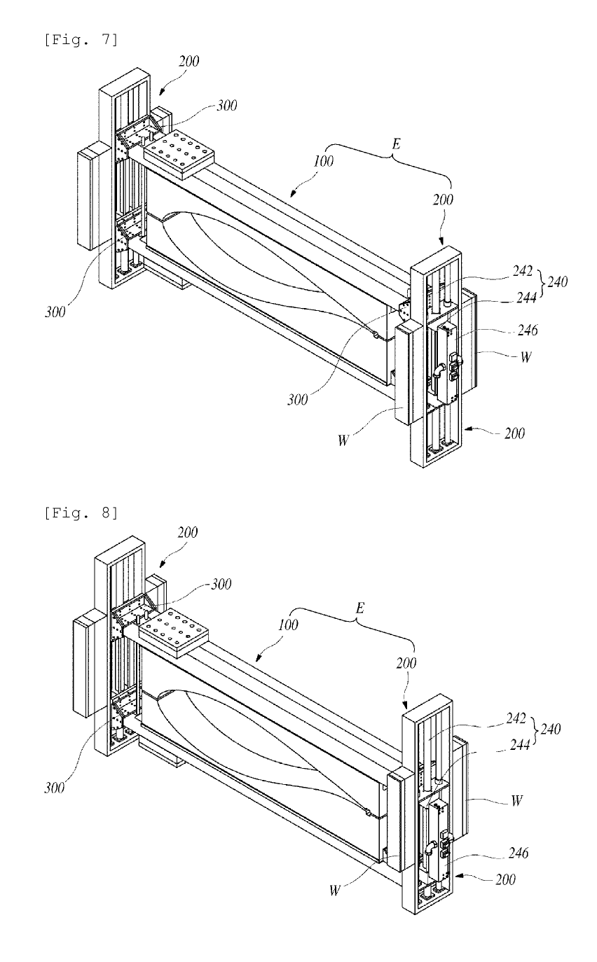

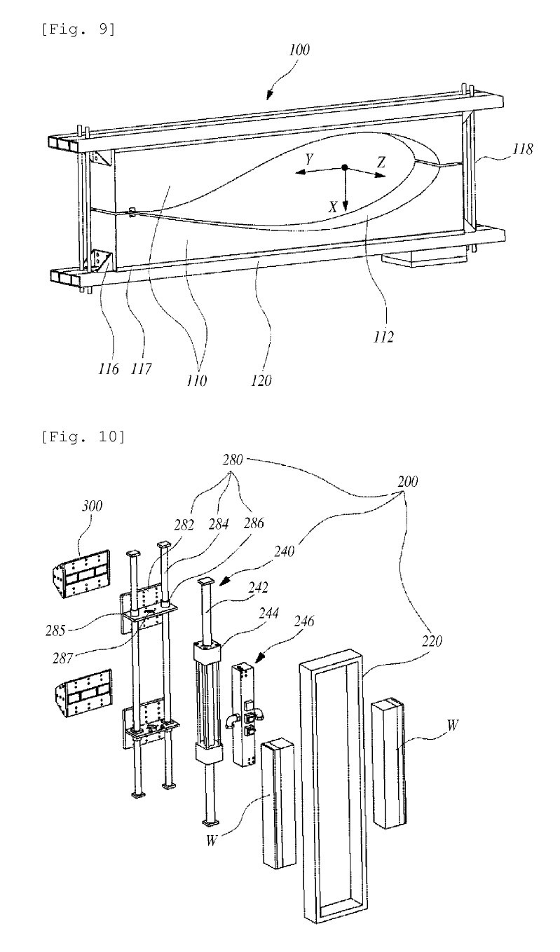

The constitution of the resonance generating apparatus E will be explained below with reference to FIGS. 7 and 8.

FIG. 7 is a perspective view illustrating outer appearance of the resonance generating apparatus for a blade's fatigue testing, according to an embodiment of the present invention, and FIG. 8 is a perspective view illustrating a weight frame, which is one of the components of the resonance generating apparatus for a blade's fatigue testing, moving upward, according to an embodiment of the present invention.

Referring to FIGS. 7 and 8, the resonance generating apparatus E includes a mounting portion 100 and a resonance generator 200. The resonance generator 200 is configured so that its center of gravity is at a pitch axis when displacement of an actuator rod 242 is “0”, while the resonance generator 200 generates resonance when the displacement of the actuator rod 242 changes (see FIG. 8).

Referring to FIG. 7, the resonance generator 200 according to a preferred embodiment of the present invention generates resonance according to the operation of the actuator 240. That is, when the actuator body 244 is maintained at a predetermined position with respect to the blade B, resonance is generated as the position of the actuator rod 242 changes.

To be more specific, the length of the actuator rod 242 varies upward and downward according to a direction in which the fluid is fed through the flowrate regulator 246. At this time, since the actuator body 244 remains at unchanged phase with respect to the blade B, the actuator rod 242 moves linearly relative to the actuator body 244.

Further, the actuator rod 242 may be protruded to the same lengths as the upper and lower sides of the actuator body 244 (see FIG. 7) according to a direction in which the fluid from the flowrate regulator 246 is introduced into the actuator 240, and then linearly move in upward and downward directions of the actuator body 244 to restrain linear reciprocal motion of the weights (W) (see FIG. 8).

The detailed constitution of the resonance generating apparatus E will be explained in detail below.

Hereinbelow, the detailed constitution of the mounting portion 100 will be explained with reference to FIG. 9. FIG. 9 is a perspective view of the mounting portion 100 as one of the components of the resonance generating apparatus E for a blade's fatigue testing, according to the present invention.

The mounting portion 100 is configured to support so that the resonance generator 200 transmits vibration forces to the blade B. The mounting portion 100 includes a saddle 110 composed of a plurality of parts and connected to surround external side of the blade B, and an assembling portion 120 configured to integrate the blade B and the saddle 110 by exerting compressive force against the saddle 110.

The mounting portion 100 may include the saddle 110 which may be composed of two or more parts and a groove 112 corresponding in form to an external shape of the blade B, and the assembling portion 120 configured to maintain the saddle 110 in mounted relationship with the blade B by generating compressive force acting from outside to inside of the saddle 110.

The groove 112 of the saddle 110 is extended in a shape that corresponds to a cross section of the blade B so that, when the parts above and below are moved close to each other, the groove 112 is brought into surface-contact with an external surface of the blade B, thus permitting forces from the resonance generating apparatus E to be transmitted to the blade B.

The assembling portion 120 is provided on an upper side and a lower side of the saddle 110. The assembling portion 120 provides the saddle 110, which may be composed of a plurality of parts, with compressive force. Additionally, the assembling portion 120 restricts the saddle 110 from oscillating in forward and backward directions or leftward and rightward directions. To this end, the assembling portion 120 may include a leftward and rightward restraint 116 to limit leftward and rightward movement (when viewed in FIG. 9) of the saddle 110, and a forward and backward restraint 117 to limit forward and backward movement of the saddle 110. Additionally, the assembling portion 120 includes a tightening member 118 on a left side and a right side to exert pressure on the saddle 110 by tightening the assembling portion 120.

The mounting portion 100 is so configured that a center of gravity thereof is positioned at a pitch axis. That is, because the center of gravity of the mounting portion 100 (including the saddle 110, the assembling portion 120 and the tightening member 118) is positioned at the pitch axis, side loads such as twisting can be prevented when the blade B is moved upward and downward due to resonance.

Further, the assembling portion 120 may be formed from composite materials to reduce weight of the resonance generating apparatus E and to increase rigidity.

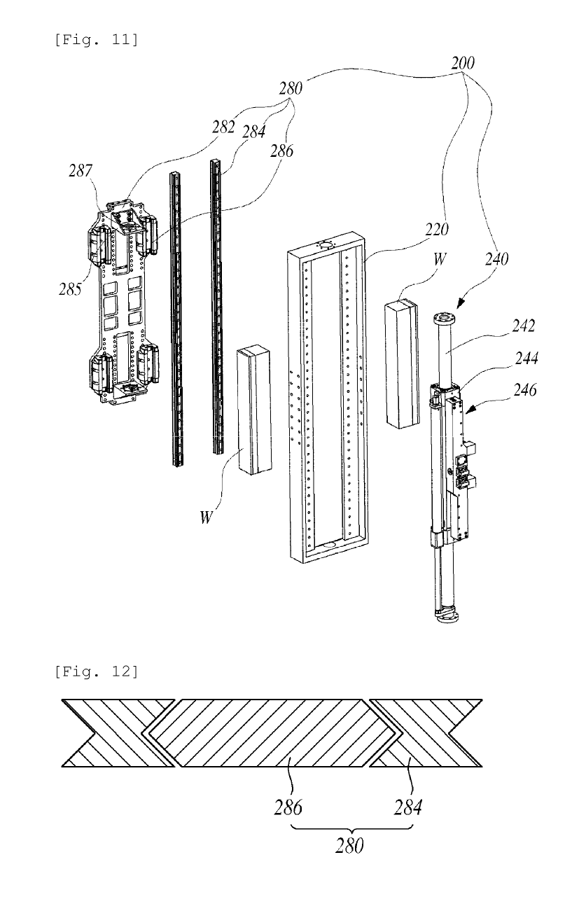

Hereinbelow, the detailed constitution of the resonance generator 200 will be explained with reference to FIG. 10.

FIG. 10 is a detailed exploded perspective of the resonance generator which is a main component of the resonance generating apparatus for a blade's fatigue testing, according to the present invention. Referring to FIG. 10, the resonance generator 200 includes an actuator 240 and is so configured that the resonance generated by the varying length of the actuator 240 is transmitted via the assembling portion 120 and via the saddle 110 and the blade B in turn.

Accordingly, the resonance generator 200 and the mounting portion 100 may be connected to each other in a variety of manners, provided that the resonance generated in accordance with extension and contraction of the length of the actuator 240 can be transmitted to the blade B.

Referring to the constitution of the embodiment illustrated in FIG. 10, the resonance generator 200 is linearly reciprocated on an outer side of the mounting portion 100 in association with the actuator 240. The resonance generator 200 includes a weight frame 220 with additional weights W provided thereon, an actuator 240 connected to one side of the weight frame 220 to generate linear reciprocal motion of the weight frame 220 and to provide the blade B with resonance, and a linear guide 280 configured to guide the movement of the weight frame 220 with respect to the mounting portion 100 when the length of the actuator 240 is extended or contracted (i.e., when the actuator rod 242 is moved).

The resonance generator 200 includes the weight frame 220 moving in association with the displacement of the actuator rod 242 of the actuator 240, in which the actuator body 244 has the same phase as the mounting portion 100.

The weight frame 220 is designed to improve structural rigidity. Referring to FIG. 10, the weight frame 220 may be hollow and configured in a closed-loop shape which is sealed off from outside. The actuator 240 is received in the weight frame 220.

Additional weights W are provided on a face that faces the weight frame 220 and may be added or reduced in number in a lengthwise direction of the blade B.

Further, the weight frame 220 may be bored in a widthwise direction of the blade B to receive the actuator 240 therein.

The linear guide 280 is configured to guide the weight frame 220 to move in association with the actuator 240, so that the weight frame 220, in a linear reciprocating manner in upward and downward directions. In one embodiment, the linear guide 280 is connected to the connector 300.

That is, the linear guide 280 guides the movement of the weight frame 220 in a direction parallel to a direction of movement of the actuator rod 242 of the actuator 240, while restricting the movement of the weight frame 220 in a direction across the direction of linear reciprocation of the actuator rod 242.

To this end, the linear guide 280 additionally includes a fixing portion 286 to maintain the same phase with respect to the blade B, and a moving portion 284 which varies phase with respect to the blade B.

Various embodiments are implementable for the fixing portion 286 and the moving portion 284, provided that these 286, 284 guide the linear reciprocal movement of the weight frame 220 and the weights W in accordance with extension and contraction of the length of the actuator 240, while restraining movement in a crossing direction.

Further, in one embodiment, a coupler 282 may be provided between the mounting portion 100 and the resonance generator 200 to connect with the connector 300. The moving portion 284, which is elongate in upward and downward directions, may be passed through the coupler 282 and slid inside the fixing portion 286 formed on the flange 285 which is extended forward from the coupler 282.

The flange 285 may include a hole 287 bored therein to receive the actuator rod 242, and upper and lower ends of the actuator rod 242 are connected to upper and lower surfaces of the interior of the weight frame 220. To this end, the width of the flange 285 may preferably correspond to inner width of the bored portion of the weight frame 220 or slightly smaller.

The flange 285 is at a distance that corresponds to the height of the actuator body 244. Opposed sides of a pair of flanges 285 are connected to upper and lower surfaces of the actuator body 244.

Accordingly, when the actuator 240 operates so that the actuator rod 242 moves, the weight frame 200 moves relative to the actuator body 244. The moving portion 284 linearly reciprocates through the fixing portion 286, to thus guide the linear reciprocal movement of the weight frame 220.

Additional weights W are connected to both sides of the weight frame 220, and these can be added or reduced in number, depending on needs.

The flowrate regulator 246 is connected to the actuator body 244 and fixed in position.

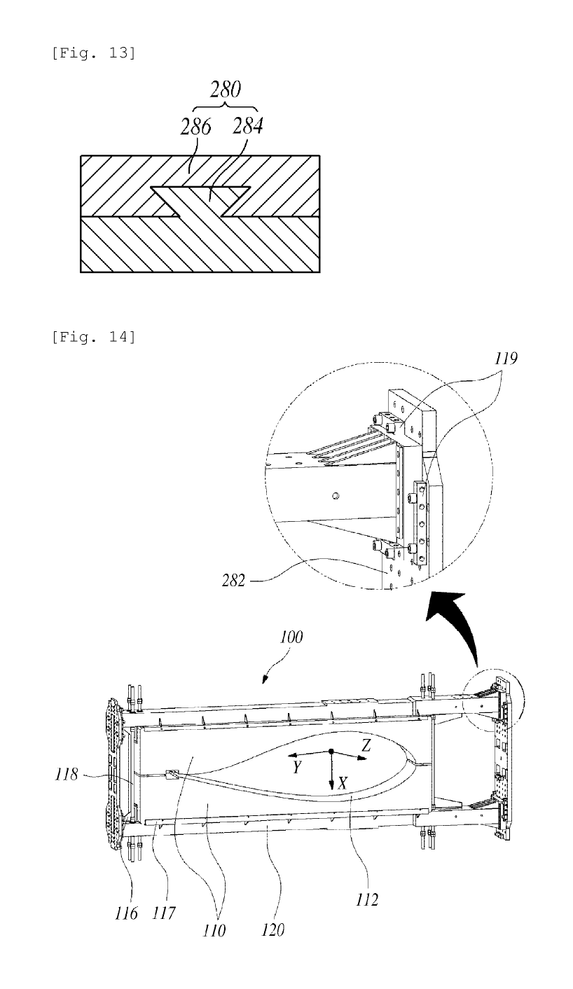

The resonance generator 200 according to another embodiment will be explained below with reference to FIG. 11. That is, FIG. 11 illustrates the resonance generator 200 in another modified embodiment. Accordingly, FIG. 11 is an exploded perspective view illustrating constitution of the resonance generating apparatus for a blade's fatigue testing, according to another embodiment of the present invention. FIG. 11 particularly illustrates an example when sufficient rigidity of the actuator 240 is ensured, in which case the connecting structure of the additional weights W and the linear guide 280 can be modified.

That is, according to the embodiment, one single coupler 282 is provided and directly connected to the mounting portion 100 without requiring the connector 300. The fixing portion 286 is connected to the coupler 282 and the moving portion 284, which is elongate in vertical direction, is connected to left and right sides of the rear side of the weight frame 220.

The actuator 240, positioned within the weight frame 220, is connected to a front surface of the coupler 282 and fixed thereat, while the upper and lower ends of the actuator rod 242 are connected to upper and lower ends of the weight frame 220 to generate movement of the weight frame 220.

As explained above, the fixing portion 286 and the moving portion 284 may be modified in various manners, provided that the weight frame 220 is linearly reciprocated during movement of the actuator rod 242.

FIG. 12 is a cross section of a linear guide of the resonance generating apparatus for a blade's fatigue testing, according to one embodiment of the present invention, and FIG. 13 is a cross section of a linear guide of a resonance generating apparatus for a blade's fatigue testing according to another embodiment of the present invention. The fixing portion 286 and the moving portion 284 are in complementary shapes to each other, and may be formed in various shapes and structures, provided that the fixing portion 286 and the moving portion 284 prevent the weight frame 220 from moving in all directions except upward and downward directions.

The connector 300 may be omitted, when sufficient rigidity of the coupler 282 is ensured, in which case the coupler 282 may be directly engaged with the assembling portion 120.

The structure of the mounting portion 100 according to another embodiment will be explained in detail below with reference to FIG. 14. FIG. 14 is a perspective view illustrating a constitution of the mounting portion of a resonance generating apparatus for a blade's fatigue testing, according to another embodiment of the present invention.

Referring to FIG. 14, the mounting portion 100 may be fixed in a manner in which the saddle 110 is lopsided. That is, because the pitch axis of the blade B is at approximately ¼ point of the blade chord, the weight ratio of the resonance generators 200 mounted on the left and right sides of the mounting portion 100 is determined in accordance with the distance ratio from the pitch axis. Accordingly, the weight W and the size of the actuator 240 vary.

It is generally not advantageous in the designing stage because excessive weight gap is generated at the resonance generators 200 in order to align the center of gravity of the left and right resonance generators 200 to the pitch axis. To alleviate the shortcoming mentioned above, the assembling portion 120 may be lengthened at one side (see FIG. 14) to thus increase a distance between the saddle 110 and the resonance generator 200. By doing so, the distance gap between the pitch axis to the resonance generators 200 on left and right sides can be alleviated.

Naturally, it is thus possible that the saddle 110 is lopsided with respect to the assembling portion 120.

The blocker 119 is provided on an end of the assembling portion 120 to increase compressive force to the counterpart, i.e., to the resonance generator 200. The blocker 119 may be connected to a predetermined area (i.e., upper, lower, left or right side) relative to the portion at which the end of the assembling portion 120 is engaged with the resonance generator 200, to limit even a minute movement of the resonance generator 200 (i.e., a movement possibly generated due to tolerance of the fastening member such as bolt).

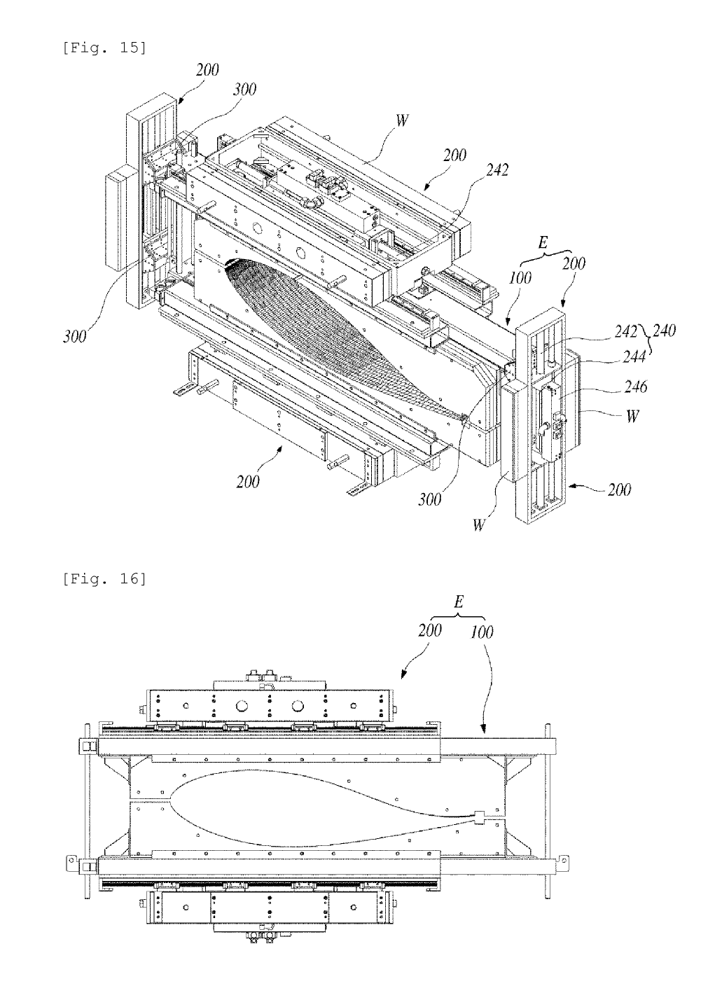

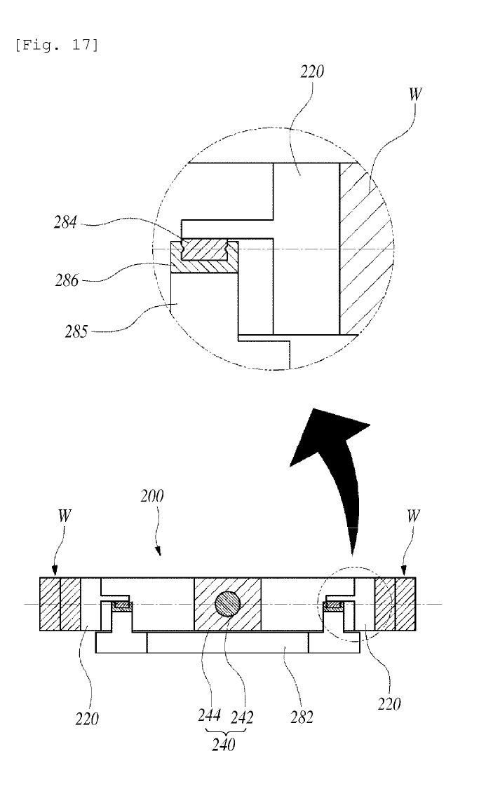

Various embodiments for installing a resonance generating apparatus for blade fatigue testing will be explained below with reference to FIGS. 15 and 16.

Referring to FIGS. 15 and 16, the resonance generator 200 is installed not only on a side surface of the mounting portion 100, but also on upper and lower sides to generate resonance in an edge direction of the blade B.

It is preferable that the resonance generator 200 is so positioned on upper and lower sides of the mounting portion 100 that the center of gravity thereof is positioned on the pitch axis when the displacement of the actuator rod 242 is “0”.

It is also possible to generate torsion on the blade (B) by combining operations of the four actuators 246 illustrated in FIG. 15 in a variety of manners. For example, the torsion is provided on the blade (B), when the actuator rods 242 of the resonance generators 200 installed opposite to each other are controlled to linearly reciprocate in opposite directions.

Meanwhile, although FIG. 16 depicts that the resonance generators 200 may be provided on left and right sides of the mounting portion 100, it is not limited thereto. Accordingly, the resonance generators 200 may be exclusively provided on upper and lower sides, in which case resonance is generated only in the direction of edge.

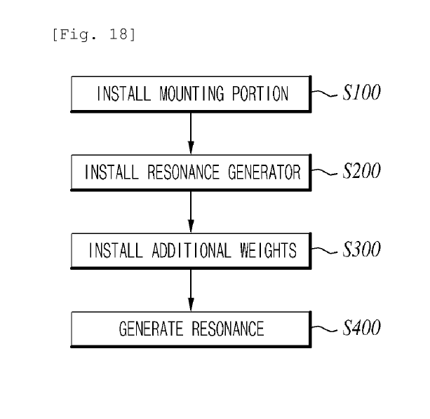

Hereinbelow, the linear guide according to another embodiment will be explained with reference to FIG. 17. FIG. 17 is a cross-section view of a linear guide of a resonance generating apparatus for a blade's fatigue testing, according to another embodiment of the present invention.

As explained above with reference to one embodiment, the moving portion 284 and the fixing portion 286 are connected in such a manner that movement in all directions is limited, except for a direction of linear reciprocation of the actuator rods 242. In one embodiment, the linear guide 280 may be positioned on a straight line extended through centers of gravity of the additional weights (W) mounted on the opposite surfaces of the linear guide 280 and the weight frame 220.

That is, when the linear guide 280 is not positioned on a straight line which is extended through the centers of gravity of the weights (S) facing each other at distance from each other with reference to the actuators 240, the resonance generated according to movement of the weights (W) generates forces in the direction across the linear reciprocal movement of the linear guide 280, and speed up wear of the moving portion 284 or the fixing portion 286.

Accordingly, to increase lifespan of the linear guide 280, the constitution as illustrated in FIG. 17 is preferable.

A fatigue testing method using the resonance generating apparatus (E) constructed as explained above, will be explained below with reference to FIG. 18.

FIG. 18 is a flowchart provided to explain a fatigue testing method using a resonance generating apparatus for a blade's fatigue testing, according to an embodiment of the present invention.

The fatigue testing method using the resonance generating apparatus for a blade's fatigue testing according to an embodiment includes sequential operations of: installing a mounting portion 100 on the blade (B) (S100), installing a resonance generator on one side of the mounting portion 100 (S200), installing the additional weights (S) on one side of the resonance generator (S300), and generating resonance on the blade (B) by causing the actuator rods to linearly reciprocate, and thus causing the weight frame and the additional weights (W) to move accordingly.

During the mounting portion installing operation (S100), the center of gravity of the mounting portion 100 is preferably positioned on a pitch axis. In the resonance generating operation (S400), the resonance may be generated in a variety of forms, according to the resonance generators installed at S200 and number of additional weights (W) installed at S300 and positions thereof.

For example, during the resonance generating operation (S400), when the direction of testing is selectively chosen among the flap direction of the blade (B) and the edge direction of the blade (B), it is necessary that the resonance generators 200 are installed on upper and lower surfaces or left and right surfaces of the mounting portion 100 and that the respective actuator rods 242 are controlled to linearly reciprocate concurrently in the same direction.

When the direction of testing in the resonance generating operation (S400) is not in the flap direction of the blade (B) or the edge direction of the blade (B), it is necessary that the resonance generators 200 are installed on all the upper and lower surfaces and left and right surfaces of the mounting portion 100 and that the respective actuator rods 242 are controlled to linearly reciprocate concurrently in the same direction.

As another example, even when the resonance generators 200 are installed only on upper and lower surfaces, or on left and right surfaces of the mounting portion 100, it is still possible to conduct fatigue testing on the torsional stress of the blade (B) by controlling the directions of operations of the respective facing actuator rods 242 to opposite directions. In this case, at the weight installing operation (S300), it is preferable that the linear guide 280 is positioned on a straight line extended through centers of gravity of the additional weights (W) installed on the facing surfaces of the linear guide 280 and the weight frame 200.

The foregoing exemplary embodiments and advantages are merely exemplary and are not to be construed as limiting the exemplary embodiments. The present teaching can be readily applied to other types of apparatuses. Also, the description of the exemplary embodiments of the present inventive concept is intended to be illustrative, and not to limit the scope of the claims.

1. A resonance generating apparatus for a blade's fatigue testing with maximized moving mass ratio, the resonance generating apparatus comprising:
a mounting portion comprising a saddle comprising a groove corresponding in form to an external surface of the blade, and an assembling portion provided outside the saddle to be tightened with a tightening member so that the saddle exerts a pressure on the blade;
a resonance generator comprising an actuator to generate linear movement, a weight frame which houses an actuator therein, has a closed-loop configuration to improve structural rigidity, and which linearly reciprocates in association with a displacement of the actuator rod, and a linear guide configured to guide the linear reciprocation of the weight frame when the actuator rod displaces; and
additional weights mounted on opposed surfaces of the weight frame to be moved in association with the weight frame, and added or reduced in number in a lengthwise direction of the blade to position the center of gravity of moving masses to the rod during linear reciprocation of the weight frame.

2. The resonance generating apparatus of claim 1, wherein the linear guide comprises:
a moving portion configured to move linearly in association with the actuator rod; and
a fixing portion configured to guide a direction of movement of the moving portion.

3. The resonance generating apparatus of claim 1, wherein a center of gravity of the resonance generator is positioned at a pitch axis, when displacement of the actuator is 0.

4. The resonance generating apparatus of claim 1, wherein a center of gravity of the mounting portion is on a pitch axis.

5. The resonance generating apparatus of claim 2, wherein the linear guide guides the movement of the weight frame to a direction parallel to a direction in which the actuator is extended or contracted.

6. The resonance generating apparatus of claim 2, wherein the linear guide restrains the movement of the weight frame to a direction across a direction in which the actuator is extended or contracted.

7. The resonance generating apparatus of claim 1, wherein the weight frame is open in a widthwise direction of the blade.

8. The resonance generating apparatus of claim 1, further comprising a blocker provided between the mounting portion and the resonance generator to limit movement of the mounting portion with respect to the resonance generator when the resonance generator generates resonance.

9. The resonance generating apparatus of claim 1, wherein the connector is formed from composite materials.

10. The resonance generating apparatus of claim 1, wherein the saddle may be changed to another position and fixed therein in a lengthwise direction of the connector.

11. The resonance generating apparatus of claim 1, wherein the resonance generator further comprises a coupler to engage the actuator body to the assembling portion.

12. The resonance generating apparatus of claim 2, wherein the linear guide is positioned on a straight line which is extended through centers of gravity of the weights mounted on the facing surfaces of the weight frame.

13. A fatigue testing method using a resonance generating apparatus with a maximized moving mass ratio for fatigue testing a blade, the fatigue testing method comprising:
installing a mounting portion on the blade, the mounting portion comprising a saddle comprising a groove corresponding in form to an external surface of the blade, and an assembling portion provided outside the saddle to be tightened with a tightening member so that the saddle exerts a pressure on the blade;
installing a resonance generator on one side of the mounting portion, the resonance generator comprising an actuator to generate linear movement, a weight frame which houses an actuator body and an actuator rod therein, has a closed-loop configuration to improve structural rigidity, and which linearly reciprocates in association with a displacement of the actuator rod, and a linear guide configured to guide the linear reciprocation of the weight frame when the actuator rod displaces;
installing additional weights on one side of the resonance generator, the weights being mounted on opposed surfaces of the weight frame to be moved in association with the weight frame, and added or reduced in number in a lengthwise direction of the blade to position the center of gravity of moving masses to the rod during linear reciprocation of the weight frame; and
generating resonance on the blade by linearly reciprocating the actuator rod of the actuator and accordingly moving the weight frame and the additional weights.

14. The fatigue testing method of claim 13, wherein installing the mounting portion comprises installing the mounting portion so that a center of gravity thereof is positioned on a pitch axis.

15. The fatigue testing method of claim 13, wherein installing the additional weights comprises positioning the linear guide on a straight line which is extended through respective centers of gravity of the weights mounted on the opposed surfaces of the weight frame.

16. The fatigue testing method of claim 13, wherein, in the generating of the resonance, the generated resonance has one direction between a flap direction and an edge direction for a direction for a blade's fatigue testing, depending on a position at which the resonance generator is installed.

17. The fatigue testing method of claim 16, wherein generating the resonance comprises generating bending or torsion in directions of the resonance generated at the blade, according to directions in which the actuator rods are moved.
